(19) United States
(12) Patent Application Publication
(10) Pub. No.: US 2023/0189811 A1
(43) Pub. Date: Jun. 22, 2023

(54) MULTILEVEL ANTIMICROBIAL POLYMERIC COLLOIDS AND DEVICE SCREENS CONTAINING SAME

(71) Applicant: THE HONG KONG UNIVERSITY OF SCIENCE AND TECHNOLOGY, Kowloon (HK)

(72) Inventors: King Lun YEUNG, Kowloon (HK); Dengyu JI, Kowloon (HK)

(21) Appl. No.: 18/073,969

(22) Filed: Dec. 2, 2022

Related U.S. Application Data
(60) Provisional application No. 63/290,613, filed on Dec. 16, 2021.

(51) Int. Cl. A01N 47/44; A01N 25/10; A01N 25/04; A01N 25/28; A01P 1/00; A01N 33/04; C08L 29/04; C08L 39/06; C09D 133/08

(52) U.S. Cl. CPC A01N 47/44; A01N 25/10; A01N 25/04; A01N 25/28; A01P 1/00; A01N 33/04; C08L 29/04; C08L 39/06; C09D 133/08; C08L 2205/22

(57) ABSTRACT

A multilevel antimicrobial polymeric colloidal particle includes a polymer scaffold and at least one antimicrobial polymer carried on the polymer scaffold, where the polymer scaffold and the at least one antimicrobial polymer form a hollow colloidal particle. An antimicrobial core may be received within the hollow colloidal particle. The multilevel antimicrobial polymeric colloidal particles may be incorporated into an optically clear acrylic material to form an antimicrobial coating. The antimicrobial coating may be coated and ultraviolet cured onto a glass, metal or plastic substrate or the like to form a screen for electronic devices or the like which has antimicrobial properties.

### CROSS-REFERENCE TO RELATED APPLICATION

This application claims the benefit of U.S. Provisional Patent Application No. 63/290,613, filed on Dec. 16, 2021.

### BACKGROUND

### 1. Field

The disclosure of the present patent application relates to antimicrobial treatments, and particularly to antimicrobial colloidal particles which may be used as additives for acrylate polymers, films, surface finishings, coatings and the like.

### 2. Description of the Related Art

Bacterial colonization and subsequent biofilm formation on materials are well known for degrading material properties, such as optical clarity, texture, and the like, as well as affecting the material's normal functioning while simultaneously putting users at risk of infection. Such concerns are particularly relevant with regard to high-touch surfaces, such as personal electronics, portable devices, light switches, door handles, kitchen countertops, stovetops, food appliance surfaces, and lavatory fixtures. Studies on electronic devices have revealed high exposure risks from contamination by environmental pathogens and skin-resident microbes. One study found that more than 80% of bacteria carried by users end up contaminating their mobile device screens. This is of particular concern due to the growing prevalence of drug-resistant organisms. Another study found a 69.9% prevalence of multidrug-resistant microbes on a common portable device screen, with about 50% of identified bacterial species being resistant to ampicillin and trimethoprim-sulfamethoxazole. Hospital patients are particularly susceptible to nosocomial infections from contaminated mobile devices. Studies have also found that poor hand hygiene and contact with electronic devices are responsible for spreading infections among hospital medical staff and people outside the hospital that the hospital staff comes into contact with. Additionally, fomites are considered an important transmission route of COVID-19, especially for high-touch electronic surfaces.

Although common cleaning agents and disinfectants are effective at removing dirt and microbial contaminants, they can corrode, damage, and leave residual harmful chemicals and products on both skin and device surfaces. Electronic devices often need to be treated with manufacturer-approved detergents which require specialized training for proper application in order to avoid surface damage, liquid infiltration, and electrical short-circuiting. Thus, multilevel antimicrobial polymeric colloids and device screens containing the same solving the aforementioned problems are desired.

### SUMMARY

The multilevel antimicrobial polymeric colloids include colloidal particles which may, as a non-limiting example, be used as antimicrobial additives for acrylate polymers, films, surface finishings, coatings and the like. The colloidal particles may be suspended in a suitable medium, such as, for example, distilled deionized (DDI) water or the like. Each multilevel antimicrobial polymeric colloidal particle includes a polymer scaffold and at least one antimicrobial polymer carried on the polymer scaffold. The polymer scaffold and the at least one antimicrobial polymer form a hollow colloidal particle. As non-limiting examples, the polymer scaffold may be formed from polyvinyl alcohol (PVA), polyvinyl pyrrolidone (PVP) or a combination thereof. As a non-limiting example, the at least one antimicrobial polymer may be at least one ionic polymer, such as polycationic polymers, polyanionic polymers or mixed ion polymers. As further non-limiting examples, the at least one antimicrobial polymer may be polyethyleneimine (PEI), polyhexamethylene biguanide (PHMB) or a combination thereof.

Each multilevel antimicrobial polymeric colloidal particle may further include a core within the hollow colloidal particle. The core may have antibacterial, antimicrobial, disinfecting, virucidal, fungicidal and/or sporicidal properties. Non-limiting examples of such materials which may be included in the core include, but are not limited to, antimicrobial metals, antimicrobial metal ions, antimicrobial metal oxides, antimicrobial chemicals, plant-derived antimicrobial phytochemicals, silver, silver compounds, silver salts, silver oxides, copper, copper compounds, copper salts, copper oxides, disinfectants, bactericidal short chain polymers, bactericidal short chain oligomers, ionic liquid compounds, alcohols, peracetic acids, essential oils, and combinations thereof.

An antimicrobial screen for use in electronics, for example, may incorporate the multilevel antimicrobial polymeric colloidal particles described above in order to impart antimicrobial properties to the screen. The antimicrobial screen includes a coating formed from an optically clear acrylic material with the multilevel antimicrobial polymeric colloidal particles incorporated therein. The coating may be coated onto a glass, metal or plastic substrate.

The antimicrobial screen may be made by mixing the multilevel antimicrobial polymeric colloidal particles with acrylate syrup to form a mixture. A radical catalyst is added to the mixture. As a non-limiting example, 2-hydroxy-2-methyl-propiophenone (2-HMP) may be used as the radical catalyst. As another non-limiting example, ammonium persulfate (APS) may be used as the radical catalyst. A layer of the mixture is coated onto a glass, metal or plastic substrate, and the layer of the mixture is cured on the substrate using ultraviolet curing. As non-limiting examples, the acrylate syrup may be 2-hydroxylpropyl acrylate (2-HPA), N,N-dimethylacrylamide (DMAA), 1,6-hexanediol diacrylate (HDDA), or combinations thereof.

These and other features of the present subject matter will become readily apparent upon further review of the following specification.

### BRIEF DESCRIPTION OF THE DRAWINGS

FIG. 1A shows an image of multilevel antimicrobial polymeric colloid particles at a magnification of 200×, where the multilevel antimicrobial polymeric colloid particles are made with a polyvinyl alcohol (PVA) scaffold carrying the antimicrobial polymers polyethyleneimine (PEI) and polyhexamethylene biguanide (PHMB).

FIG. 1B shows an image of multilevel antimicrobial polymeric colloid particles at a magnification of 200×, where the multilevel antimicrobial polymeric colloid particles are made with a polyvinyl pyrrolidone (PVP) scaffold carrying the antimicrobial polymers polyethyleneimine (PEI) and polyhexamethylene biguanide (PHMB).

FIG. 2A illustrates the photocleavage of 2-hydroxy-2-methyl-propiophenone (2-HMP) under ultraviolet (UV) excitation during UV curing of a multilevel antimicrobial polymeric colloidal coating.

FIG. 2B illustrates 2-hydroxylpropyl acrylate (2-HPA) polymerization with radical catalysis using a 2-HMP radical catalyst during UV curing of the multilevel antimicrobial polymeric colloidal coating.

FIG. 2C illustrates N,N-dimethylacrylamide (DMAA) polymerization with radical catalysis using a 2-HMP radical catalyst during UV curing of the multilevel antimicrobial polymeric colloidal coating.

FIG. 3 is a side view in section of an antimicrobial screen made from a glass substrate with a cured acrylic and multilevel antimicrobial polymeric (MAP) layer coated thereon.

FIG. 4 is a graph showing the measured thickness of a cured DMAA and MAP-1 coating layer and the measured thickness of a cured 2-HPA and MAP-P coating layer, where the thickness for each sample was measured at eight test points.

FIG. 5 is a graph showing the measured roughness of a cured DMAA and MAP-1 coating layer and the measured roughness of a cured 2-HPA and MAP-P coating layer, where the roughness for each sample was measured at eight test points.

FIG. 6A shows an optical microscope image of a cured DMAA and MAP-1 coating layer at a magnification of 100×.

FIG. 6B shows an optical microscope image of a cured 2-HPA and MAP-P coating layer at a magnification of 100×.

FIG. 7A shows an optical microscope image of a cured 2-HPA and MAP-P coating layer at a magnification of 500×.

FIG. 7B shows another optical microscope image of a cured 2-HPA and MAP-P coating layer at a magnification of 500×.

FIG. 8 is a graph showing optical transmittance results for a cured DMAA and MAP-1 coating layer sample and a cured 2-HPA and MAP-P coating layer sample.

FIG. 9 is a graph showing swelling ratio and gel fraction test results for a screen sample prepared with 2-HPA and MAP-P.

FIG. 10 shows plots of logio reduction in colony forming units (CFU) of bacteria recovered from cured acrylate-MAP samples after 60 seconds of contact.

FIG. 11 shows plots of log₁₀ reduction in colony forming units (CFU) of bacteria and plaque forming units (PFU) for bacteriophages recovered from cured acrylate-MAP samples after 10 minutes of contact.

Similar reference characters denote corresponding features consistently throughout the attached drawings.

### DETAILED DESCRIPTION OF THE PREFERRED EMBODIMENTS

The multilevel antimicrobial polymeric colloids include colloidal particles which may, as a non-limiting example, be used as antimicrobial additives for acrylate polymers, films, surface finishings, coatings and the like. The colloidal particles may be suspended in a suitable medium, such as, for example, distilled deionized (DDI) water or the like. Each multilevel antimicrobial polymeric colloidal particle includes a polymer scaffold and at least one antimicrobial polymer carried on the polymer scaffold. The polymer scaffold and the at least one antimicrobial polymer form a hollow colloidal particle. As non-limiting examples, the polymer scaffold may be formed from polyvinyl alcohol (PVA), polyvinyl pyrrolidone (PVP) or a combination thereof. As a non-limiting example, the at least one antimicrobial polymer may be at least one ionic polymer, such as polycationic polymers, polyanionic polymers or mixed ion polymers. As further non-limiting examples, the at least one antimicrobial polymer may be polyethyleneimine (PEI), polyhexamethylene biguanide (PHMB) or a combination thereof.

Each multilevel antimicrobial polymeric colloidal particle may further include a core within the hollow colloidal particle. The core may have antibacterial, antimicrobial, disinfecting, virucidal, fungicidal and/or sporicidal properties. Non-limiting examples of such materials which may be included in the core include, but are not limited to, antimicrobial metals, antimicrobial metal ions, antimicrobial metal oxides, antimicrobial chemicals, plant-derived antimicrobial phytochemicals, silver, silver compounds, silver salts, silver oxides, copper, copper compounds, copper salts, copper oxides, disinfectants, bactericidal short chain polymers, bactericidal short chain oligomers, ionic liquid compounds, alcohols, peracetic acids, essential oils, and combinations thereof.

Table 1 below shows the composition of four exemplary multilevel antimicrobial polymeric (MAP) colloids, referred to herein as “MAP-1”; “MAP-1 2*”; “MAP-P”; and “MAP-P 2*”.

TABLE 1
Compositions of Exemplary MAP Colloids

| Components | MAP-1 | MAP-1 2* | MAP-P | MAP-P 2* |
|---|---|---|---|---|
| PVA | 4.17 w/w % | 4.17 w/w % | — | — |
| PVP | — | — | 4.17 w/w % | 4.17 w/w % |
| PHMB | 0.33 w/w % | 0.67 w/w % | 0.33 w/w % | 0.67 w/w % |
| PEI | 1.33 w/w % | 2.67 w/w % | 1.33 w/w % | 2.67 w/w % |
| DDI | 94.17 w/w % | 92.49 w/w % | 94.17 w/w % | 92.49 w/w % |

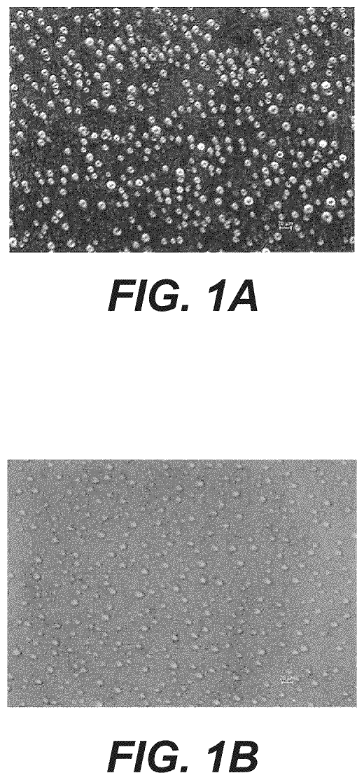

FIGS. 1A and 1B show images of MAP-1 and MAP-P particles, respectively, at a magnification of 200×. For FIGS. 1A and 1B, MAP-1 and MAP-P colloids were prepared with hollow cores. 100 μL of each was deposited on a 2.54×2.54 cm² glass slide and dried for an hour at room temperature. The images shown in FIGS. 1A and 1B were produced using a Nikon® Eclipse Ni2 microscope in bright field and a CCD camera.

FIG. 1A shows an image of multilevel antimicrobial polymeric colloid particles at a magnification of 200×, where the multilevel antimicrobial polymeric colloid particles are made with a polyvinyl alcohol (PVA) scaffold carrying the antimicrobial polymers polyethyleneimine (PEI) and polyhexamethylene biguanide (PHMB).

FIG. 1B shows an image of multilevel antimicrobial polymeric colloid particles at a magnification of 200×, where the multilevel antimicrobial polymeric colloid particles are made with a polyvinyl pyrrolidone (PVP) scaffold carrying the antimicrobial polymers polyethyleneimine (PEI) and polyhexamethylene biguanide (PHMB).

An antimicrobial screen for use in electronics, for example, may incorporate the multilevel antimicrobial polymeric colloidal particles described above in order to impart antimicrobial properties to the screen. The antimicrobial screen includes a coating formed from an optically clear acrylic material with the multilevel antimicrobial polymeric colloidal particles incorporated therein. The coating may be coated onto a glass, metal or plastic substrate.

The antimicrobial screen may be made by mixing the multilevel antimicrobial polymeric colloidal particles with an acrylate syrup under rapid mixing to form a viscous mixture. A radical catalyst is added to the mixture. As a non-limiting example, 2-hydroxy-2-methyl-propiophenone (2-HMP) may be used as the radical catalyst. As another non-limiting example, ammonium persulfate (APS) may be used as the radical catalyst. A layer of the mixture is coated onto a glass, metal or plastic substrate, and the layer of the mixture is cured on the substrate using ultraviolet curing. As non-limiting examples, the acrylate may be 2-hydroxylpropyl acrylate (2-HPA), N,N-dimethylacrylamide (DMAA), 1,6-hexanediol diacrylate (HDDA), or combinations thereof. Ultraviolet (UV) exposure (at, for example, 352 nm) induces 2-HMP photocleavage to produce benzoyl radicals and α-hydroxyalkyl radicals catalyzing acrylate step polymerization.

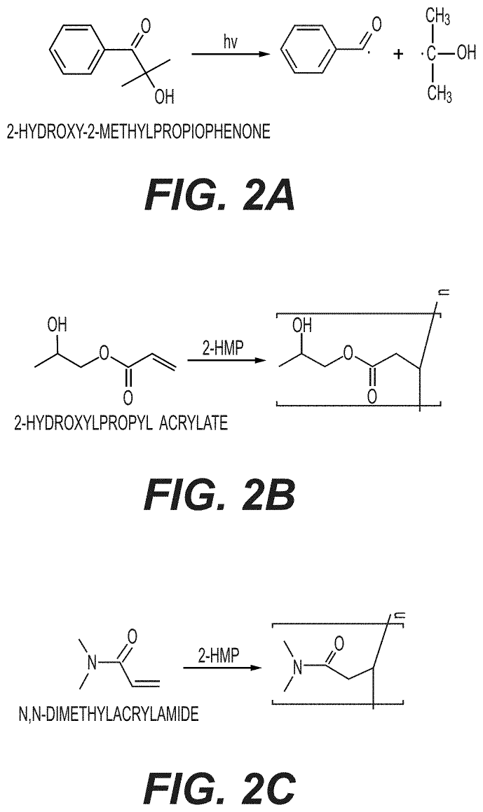

FIG. 2A illustrates the photocleavage of 2-hydroxy-2-methyl-propiophenone (2-HMP) under ultraviolet (UV) excitation. FIG. 2B illustrates 2-hydroxylpropyl acrylate (2-HPA) polymerization with radical catalysis using a 2-HMP radical catalyst. FIG. 2C illustrates N,N-dimethylacrylamide (DMAA) polymerization with radical catalysis using a 2-HMP radical catalyst.

Table 2 below shows the compositions of exemplary antimicrobial screens prepared as described above, where MAP-P colloids are used in combination with 2-HPA, and MAP-1 colloids are used in combination with DMAA.

TABLE 2
Compositions of Exemplary Screens

| | Formulas | | | | |
|---|---|---|---|---|---|
| Components | 2-HPA & MAP-P | | DMAA & MAP-1 | | Concentration |
| Acrylate scaffold | 2-HPA | | DMAA | | 88 v/v % |
| MAP colloid | MAP-P | MAP-P2* | MAP-1 | MAP-12* | 10 v/v % |

| | | |
|---|---|---|
| Radical catalyst | 2-Hydroxy-2-methylpropiophenone (2-HMP) | 1 w/w % |
| | Ammonium Persulfate (APS) | 0.25 w/w % |

In experiments, acrylate-MAP mixtures were prepared with 0.5 mL MAP-1 or MAP-P solutions (made with DDI water) added to 4.4 mL of DMAA or 2-HPA acrylates, followed by vortexing for 1 minute. The prepared acrylate-MAP mixtures were each deposited on a 2.54×2.54 cm² area of a glass slide with a bar coater. The deposited acrylate-MAP layer was covered with a polyethylene terephthalate (PET) release film to avoid oxidizing the acrylate. Each acrylate-MAP layer was bar coated at a thickness of 50 μm. UV curing was performed in a chamber with a fluence of 2.5 mW/cm². The main UV wavelength was 352 nm, with an exposure duration of 2 hours˜7 hours, a temperature of 19.2° C.˜19.5° C., and a humidity level of 33% RH˜37% RH.

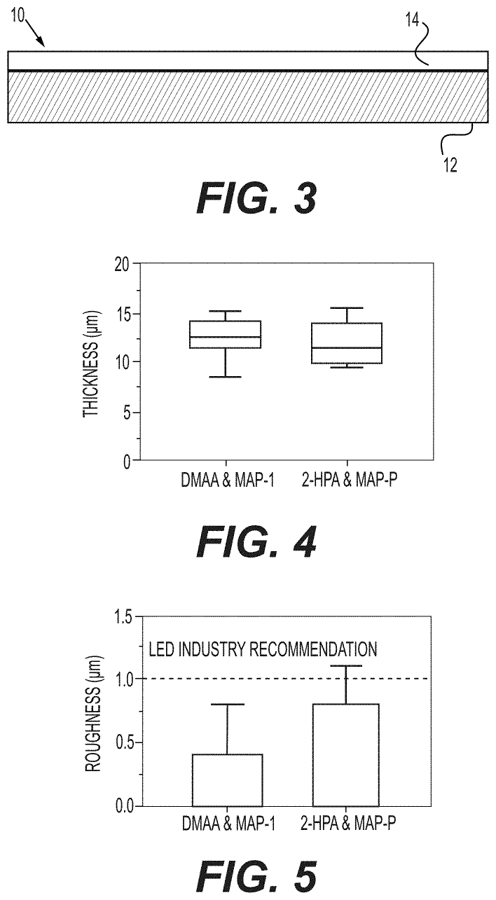

Following UV curing of DMAA & MAP-1 and 2-HPA & MAP-P samples, the release film was torn off, leaving the acrylate-MAP coating layer intact. FIG. 3 illustrates a sample screen 10 formed from glass substrate 12 with a cured acrylate-MAP layer 14 coated thereon. The sample formed from DMAA and MAP-1 was found to adhere to glass, while the sample formed from 2-HPA and MAP-P was found to adhere to PET. Both samples were perfectly cured without surface defects or residues. The sample thickness and surface roughness were measured using a Digimatic® Micrometer, manufactured by Mitutoyo®, and a pressing-probe roughness meter, respectively. Roughness measurements were performed following the ISO 1302 standard.

FIG. 4 shows the measured thickness of cured DMAA & MAP-1 and cured 2-HPA & MAP-P samples at eight test points per sample. FIG. 5 shows the measured roughness of cured DMAA & MAP-1 and 2-HPA & MAP-P samples at eight test points per sample. As indicated in FIG. 5, the measured roughness is less than the maximum allowed roughness of 1 μm for LED panels. The average thickness±the standard deviation (SD) for the DMAA & MAP-1 screen sample is 12.5±1.4 μm. The average thickness±SD for the 2-HPA & MAP-P screen sample is 11.9±1.8 μm. The average roughness±SD for the DMAA & MAP-1 screen sample is 0.4±0.4 μm. The average roughness±SD for the 2-HPA & MAP-P screen sample is 0.8±0.3 μm.

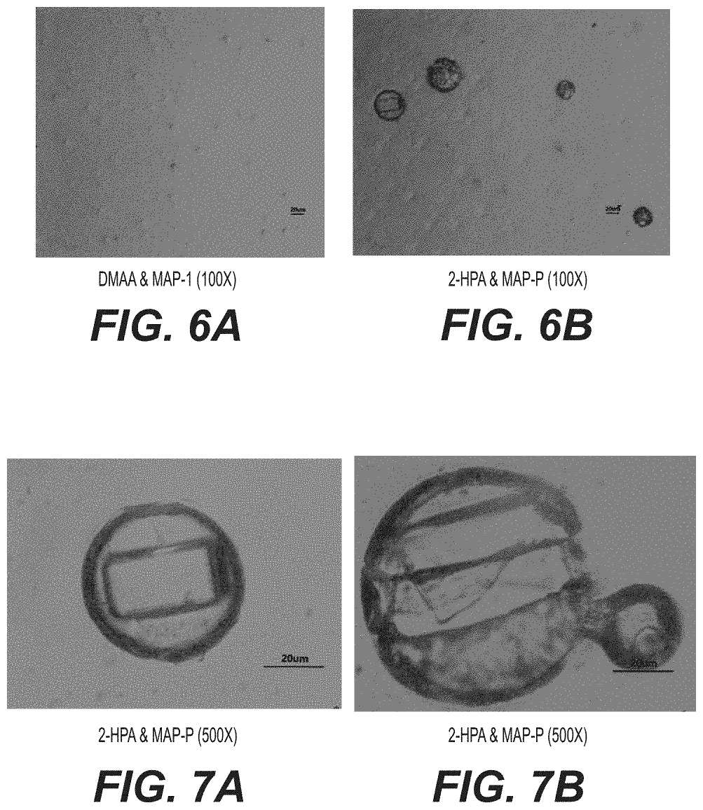

The cured acrylate-MAP samples were examined under an optical microscope, as shown in FIGS. 6A and 6B, and the MAP colloids are seen to be embedded within the acrylate, indicating that the curing process did not damage the colloids. The MAP colloids are more apparent for the 2-HPA & MAP-P samples at higher magnification, as shown in FIGS. 7A and 7B, where regular crystals are seen within the hollows of the MAP colloids. These PEI/PHMB crystals serve as added reservoir of antimicrobial for surface disinfection.

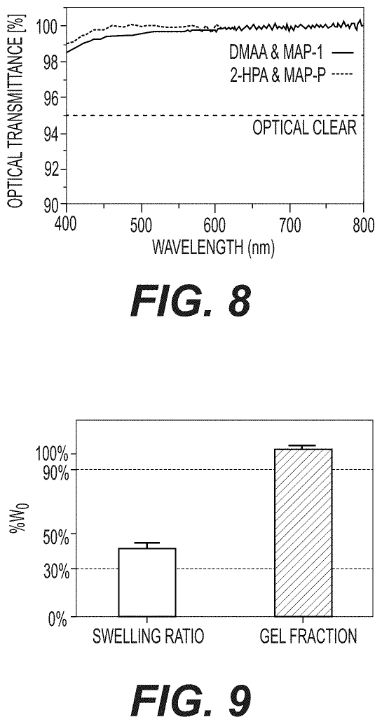

The optical transmittance or transparency of the cured acrylate-MAP samples were determined by a Varioscan spectrophotometer according to chapter “5.10 Opacity” of the ISO/IEC 10373-1:2006(E) standard. As shown in FIG. 8, the acrylate-MAP samples have better than 95% light transmittance for wavelengths in the visible region (i.e., 400-800 nm) and are therefore considered to be “optically clear.” Measurements were made over 400-800 nm in duplicate samples of each formula. In FIG. 8, the dashed line represents 95% transmittance.

The swelling ratio and gel fraction tests are convenient methods for measuring the quantity of insoluble components in a sample and the degree of crosslinking in polymers. The swelling ratio represents the fraction increase after water adsorption from oligomers and free polymers not crosslinked into the polymer network. The gel fraction measures the quantity of insoluble components after soaking and drying, usually representing the fraction of crosslinked or networked polymers. The cured acrylate-MAP samples were hydrated by soaking in 37° C. water for 36 hours, following the protocols published in the ASTM D2765 and ISO 54759 standards. The swelling ratios were obtained as additional fraction to the initial weight w₀. The samples were further dried at 60° C. in an oven until a constant weight was obtained. The gel fraction was the ratio of the dry weight to the initial weight. The swelling ratio and the gel fraction were calculated as follows:

$$Swelling ratio [ \% ] = \frac{{w}_{i} - {w}_{0}}{{w}_{0}} ⨯ 100 \% \qquad ( 1 )$$

$$Gel fraction [ \% ] = \frac{{w}_{D}}{{w}_{0}} ⨯ 100 \% , \qquad ( 2 )$$

where w₀ is the initial weight, wᵢ is the sample weight after immersing it in 37° C. DDI water for 36 hours, and w_{D} is the dry weight after drying at 60° C. for 2 hours.

For the swelling ratio and gel fraction tests, 2-HPA and MAP-P screens were immersed in 37° C. DDI water for 36 hours, as discussed above. Visual inspection showed that the cured acrylate-MAPs were identical in appearance before and after the swelling ratio and gel fraction tests. The swelling ratio of the 2-HPA and MAP-P screen was about 30% and the gel fraction was over 99%, indicating that the samples are insoluble in water and are fully crosslinked. This also confirmed that MAP incorporation does not affect the appearance nor the mechanical properties of the acrylate material. FIG. 9 shows the results of the swelling ratio and gel fraction tests for the 2-HPA and MAP-P screen samples, where the 30% dashed line of the swelling ratio indicates a well-crosslinked network, and the 90% dashed line of the gel fraction also confirms stable and insoluble network formation (for duplicate samples).

The antimicrobial properties of cured acrylate-MAP screen samples were tested against S. aureus, E. coli, and Φ6 bacteriophage (a virus surrogate). The Φ6 bacteriophage belongs to the only known family of enveloped phages, Cystoviridae. Its lipid envelope is reported to exert a similar role as human infective virus under survival trials. Tests were conducted on 2.54×2.54 cm² pieces of cured acrylate-MAP screen at room conditions for contact times of either 60 seconds or 10 minutes. The test conditions and operations complied with the European standard EN 13727, as well as the requirements of ISO 22196, ASTM E3031, JIS L-1902, 2002, and GB-21551.2-2020.

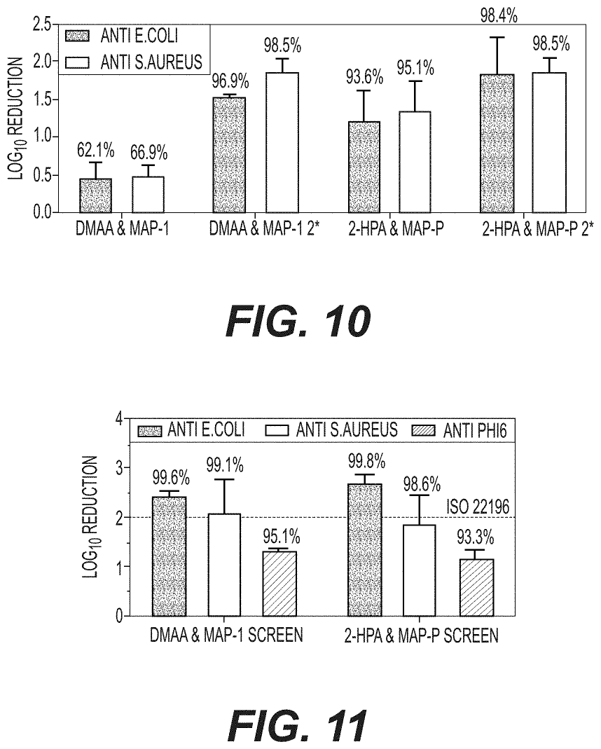

The 2.54×2.54 cm² pieces of cured acrylate-MAP screen were deliberately challenged with 10⁶ CFU of bacteria and PFU of bacteriophages. After 60 seconds or 10 minutes of contact at room temperature (20° C.) and humidity (ca. 60% R.H.), the samples were vortexed in D/E neutralizing broth containing 3% Tween® 80, 3% saponin and 0.3% lecithin at pH 7.0. As shown in FIG. 10, the viability of E. coli and S. aureus decreased by over 98% after 60 seconds of contact, indicating rapid surface disinfection. FIG. 11 shows that the acrylate-MAP can attain 99% reduction of bacteria after 10 minutes of contact, thus meeting the ISO 22196 requirement. The viable Φ6 bacteriophage decreased by more than 90%. Blank acrylates serving as a negative control had no bactericidal or virucidal activities. Testing was performed using triplicate samples.

Tables 3 and 4 shows the results of the bactericidal and virucidal testing of the acrylate-MAP samples after 60 seconds of contact and 10 minutes of contact, respectively.

TABLE 3
Bactericidal Results after 60 Seconds of Contact

| Log₁₀ reduction (Avg. ± SD)/ | Gram (−) | Gram (+) |
|---|---|---|
| Percent reduction | E. coli | S. aureus |
| DMAA & MAP-1 screen | 0.42 ± 0.26/62.1% | 0.48 ± 0.16/66.9% |
| DMAA & MAP-1 2* screen | 1.51 ± 0.05/96.9% | 1.83 ± 0.21/98.5% |
| 2-HPA & MAP-P screen | 1.19 ± 0.42/93.6% | 1.31 ± 0.43/95.1% |
| 2-HPA & MAP-P 2* screen | 1.80 ± 0.51/98.4% | 1.83 ± 0.21/98.5% |

TABLE 4
Bactericidal and Virucidal Results after 10 Minutes of Contact

| Log₁₀ reduction (Avg. ± SD)/ | Gram (−) | Gram (+) | Phage virus |
|---|---|---|---|
| Percent reduction | E. coli | S. aureus | Φ6 |
| DMAA & MAP-1 screen | 2.37 ± 0.16/ | 2.07 ± 0.71/ | 1.31 ± 0.06/ |
| | 99.6% | 99.1% | 95.1% |
| 2-HPA & MAP-P screen | 2.66 ± 0.21/ | 1.85 ± 0.61/ | 1.17 ± 0.17/ |
| | 99.8% | 98.6% | 93.3% |
| ISO 22196 | √ | [symbol] | X |
| ASTM E3031 | √ | √ | √ |

It is to be understood that the multilevel antimicrobial polymeric colloids and device screens containing the same are not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A multilevel antimicrobial polymeric colloidal particle, comprising:
a polymer scaffold; and
at least one antimicrobial polymer carried on the polymer scaffold,
wherein the polymer scaffold and the at least one antimicrobial polymer form a hollow colloidal particle.

2. The multilevel antimicrobial polymeric colloidal particle as recited in claim 1, wherein the polymer scaffold comprises a polymer selected from the group consisting of polyvinyl alcohol (PVA), polyvinyl pyrrolidone (PVP) and a combination thereof.

3. The multilevel antimicrobial polymeric colloidal particle as recited in claim 1, wherein the at least one antimicrobial polymer comprises at least one ionic polymer.

4. The multilevel antimicrobial polymeric colloidal particle as recited in claim 3, wherein the at least one ionic polymer is selected from the group consisting of polycationic polymers, polyanionic polymers, and mixed ion polymers.

5. The multilevel antimicrobial polymeric colloidal particle as recited in claim 1, wherein the at least one antimicrobial polymer is selected from the group consisting of polyethyleneimine (PEI), polyhexamethylene biguanide (PHMB), and a combination thereof.

6. The multilevel antimicrobial polymeric colloidal particle as recited in claim 1, further comprising an antimicrobial core within the hollow colloidal particle.

7. The multilevel antimicrobial polymeric colloidal particle as recited in claim 6, wherein the antimicrobial core comprises an antimicrobial agent selected from the group consisting of antimicrobial metals, antimicrobial metal ions, antimicrobial metal oxides, antimicrobial chemicals, plant-derived antimicrobial phytochemicals, silver, silver compounds, silver salts, silver oxides, copper, copper compounds, copper salts, copper oxides, disinfectants, bactericidal short chain polymers, bactericidal short chain oligomers, ionic liquid compounds, alcohols, peracetic acids, essential oils, and combinations thereof.

8. An antimicrobial screen, comprising:
a coating comprising an optically clear acrylic material and multilevel antimicrobial polymeric colloidal particles incorporated into the optically clear acrylic material, wherein each of the multilevel antimicrobial polymeric colloidal particles comprises:
a polymer scaffold; and
at least one antimicrobial polymer carried on the polymer scaffold,
wherein the polymer scaffold and the at least one antimicrobial polymer form a hollow colloidal particle; and
a substrate comprising a material selected from the group consisting of glass, metal and plastic,
wherein the coating is coated onto the substrate.

9. The antimicrobial screen as recited in claim 8, wherein the polymer scaffold comprises a polymer selected from the group consisting of polyvinyl alcohol (PVA), polyvinyl pyrrolidone (PVP) and a combination thereof.

10. The antimicrobial screen as recited in claim 8, wherein the at least one antimicrobial polymer comprises at least one ionic polymer.

11. The antimicrobial screen as recited in claim 10, wherein the at least one ionic polymer is selected from the group consisting of polycationic polymers, polyanionic polymers, and mixed ion polymers.

12. The antimicrobial screen as recited in claim 8, wherein the at least one antimicrobial polymer is selected from the group consisting of polyethyleneimine (PEI), polyhexamethylene biguanide (PHMB), and a combination thereof.

13. The antimicrobial screen as recited in claim 8, wherein each of the multilevel antimicrobial polymeric colloidal particles comprises an antimicrobial core within the hollow colloidal particle.

14. The antimicrobial screen as recited in claim 13, wherein the antimicrobial core comprises an antimicrobial agent selected from the group consisting of antimicrobial metals, antimicrobial metal ions, antimicrobial metal oxides, antimicrobial chemicals, plant-derived antimicrobial phytochemicals, silver, silver compounds, silver salts, silver oxides, copper, copper compounds, copper salts, copper oxides, disinfectants, bactericidal short chain polymers, bactericidal short chain oligomers, ionic liquid compounds, alcohols, peracetic acids, essential oils, and combinations thereof.

15. A method of making an antimicrobial screen, comprising the steps of:
mixing multilevel antimicrobial polymeric colloidal particles and an acrylate syrup to form a mixture, wherein each of the multilevel antimicrobial polymeric colloidal particles comprises a polymer scaffold and at least one antimicrobial polymer carried on the polymer scaffold, wherein the polymer scaffold and the at least one antimicrobial polymer form a hollow colloidal particle;
7 adding a radical catalyst to the mixture;
coating a layer of the mixture onto a substrate, wherein the substrate comprises a material selected from the group consisting of glass, metal and plastic; and
curing the layer of the mixture using ultraviolet curing.

16. The method of making an antimicrobial screen as recited in claim 15, wherein the acrylate syrup is selected from the group consisting of 2-hydroxylpropyl acrylate (2-HPA), N,N-dimethylacrylamide (DMAA), 1,6-hexanediol diacrylate (HDDA), and combinations thereof.

17. The method of making an antimicrobial screen as recited in claim 15, wherein the polymer scaffold comprises a polymer selected from the group consisting of polyvinyl alcohol (PVA), polyvinyl pyrrolidone (PVP) and a combination thereof.

18. The method of making an antimicrobial screen as recited in claim 15, wherein the at least one antimicrobial polymer is selected from the group consisting of polyethyleneimine (PEI), polyhexamethylene biguanide (PHMB), and a combination thereof.

19. The method of making an antimicrobial screen as recited in claim 15, wherein each of the multilevel antimicrobial polymeric colloidal particles comprises an antimicrobial core within the hollow colloidal particle.

20. The method of making an antimicrobial screen as recited in claim 19, wherein the antimicrobial core comprises an antimicrobial agent selected from the group consisting of antimicrobial metals, antimicrobial metal ions, antimicrobial metal oxides, antimicrobial chemicals, plant-derived antimicrobial phytochemicals, silver, silver compounds, silver salts, silver oxides, copper, copper compounds, copper salts, copper oxides, disinfectants, bactericidal short chain polymers, bactericidal short chain oligomers, ionic liquid compounds, alcohols, peracetic acids, essential oils, and combinations thereof.
